(19) United States
(12) Patent Application Publication
(10) Pub. No.: US 2014/0192188 A1
(43) Pub. Date: Jul. 10, 2014

(54) DEVICE AND METHOD FOR ENHANCING COVERT OPERATIONS IN HOSTILE ENVIRONMENTS BY REDUCING BANDWIDTH AND POWER REQUIREMENTS

(71) Applicant: Technology Advancement Group, Inc., (US)

(72) Inventors: John Arthur McEwan, Alexandria, VA (US); Trevor Landon, Vienna, VA (US)

(73) Assignee: Technology Advancement Group, Inc., Dulles, VA (US)

(21) Appl. No.: 13/683,652

(22) Filed: Nov. 21, 2012

(51) Int. Cl. H04N 7/18; G06K 9/00

(52) U.S. Cl. CPC H04N 7/183; G06K 9/00288
USPC 348/143; 702/189

(57) ABSTRACT

A compact sensor system with intelligent processing capabilities to reduce power usage and transmission bandwidth requirements is disclosed. The compact sensor system comprises a housing containing at least one sensor, processor, and processor readable media. The processor is connected to a circuit board, which is mounted to the interior of the housing. The processor executes software instructions stored in the processor readable media causing the processor to receive and analyze data from the sensor, the processing including identifying bits in the sensor data, analyzing the bits using segmentation, and describing the bits using a data representation. After processing the data, the processor may transmit the data, selected portions of the data, or a confirmation signal to an external system.

### BACKGROUND OF THE INVENTION

1. Field of the Invention

The present invention relates generally to intelligent sensor systems, and more particularly to sensor systems with intelligent transmission control designed for use in environments where bandwidth and power are at a premium, e.g. when conducting covert reconnaissance in hostile environments.

2. Background of the Invention

Covert information gathering is critically important for numerous reasons. Often referred to as intelligence, surveillance, and reconnaissance (“ISR”), this information can be valuable to develop military strategy, defend against terrorist attack, and assist law enforcement.

One challenge in gathering useful ISR information is the need to power remote sensors used for gathering information. These challenges are exacerbated when the remote sensor must operate covertly in a hostile environment. A covertly operated remote sensor in hostile territory does not have easy access to a power source. Using a large solar panel, which must be exposed to broad daylight, is often not practical as this will lead to easy detection of the covertly positioned equipment. If battery power is used, the power is limited by the size of the battery, and it may be difficult or impossible to dispatch a technician to replace a battery for a remote sensor in hostile territory. And if a large battery is used, the remote sensor will be large and therefore easier to find. Therefore, power is often at a premium in remote sensor systems.

An additional challenge involves the communication of information gathered by the remote sensor. Once the sensor gathers information it must somehow convey that information in order for it to be acted upon. As the information is likely highly time-sensitive, it is impractical to dispatch a technician to check the sensor and collect the data, as the value of the information may have already expired. Also, it may be impractical or dangerous to send a technician if the sensor is located in a hostile environment.

Since the sensor's information is typically desired in real time, it may be conveyed via electromagnetic signal by a radio. For example, the sensor may be aboard an Unmanned Aerial Vehicle providing radio communications via a satellite. It is highly desirable to keep radio communication to a minimum for at least three reasons. First, the radio transmission is subject to detection, deception, interference, and jamming (“D2IJ”). Another reason to minimize radio communication is the communications equipment requires power for every second it is operating, and especially when it is transmitting. In addition to using valuable power and increasing the chance of D2IJ, prolonged communication requires large available bandwidth, which may either not be available at all or comes at a very high cost. In the satellite communications example, the satellite bandwidth is limited and comes at a high cost: often Unmanned Aerial Vehicles are assigned a limited amount of satellite capacity which limits the number of sensors sending raw data at any given time to just one.

For all of the above reasons, it is highly desirable to develop a sensor that can collect, analyze, and transmit valuable information, while minimizing power consumption, D2IJ susceptibility, and communication bandwidth.

### SUMMARY

Embodiments according to aspects of the present invention are directed to intelligent sensor systems. Aspects of the present invention include specialized data analysis and transmission capabilities to provide systems for conducting reconnaissance in hostile environments.

According to one aspect of the present invention, a compact sensor system includes a housing incorporating a sensor, a high-powered general purpose processor, a processor readable media, and a heat reduction system. The processor is disposed on a circuit board which is contained in the housing. The processor receives sensor data from the sensor, and, according to software instructions stored on the processor readable media, the processor identifies bits in the sensor data, analyzes the bits via segmentation of the sensor data, and describes the segmented sensor data using a data representation.

In a first mode, the processor transmits output data containing a description of the segmented sensor data to a remote location. In a second mode, the amount of output data is reduced such that the processor only transmits a fractional amount of data as compared to the original sensor data. In a third mode, the processor receives a target data set from an external source, and, when a match between the sensor data and the target data is recognized, the processor transmits data indicating the recognition of the target. In yet another mode, upon detecting a match the processor transmits only a confirmation signal without any sensor data.

In one embodiment, the sensor is configured to capture thermal imaging data. In another embodiment, the sensor is a camera capturing image data. In yet another embodiment, the sensor is configured to capture electromagnetic radiation occurring outside of the visible spectrum, such as, but not limited to, infrared or ultraviolet data. In still other embodiments, multiple sensors are combined into the same system.

In some embodiments, the processor is disposed on a flexible circuit board or multiple circuit board sections connected by flexible connectors. In some embodiments, the circuit board sections are positioned such that a section of the board is perpendicular to another section of the board. Additionally, in some embodiments, portions of the circuit board may be coupled to the housing to, at least, assist with dissipating heat from the processor. In some embodiments, the housing includes an external cooling fin or conductive mounting tab that assists with dissipating heat.

In some embodiments, the system is powered by a battery. In some embodiments, the battery is rechargeable by solar power. In some embodiments, the system is configured to shut off periodically to conserve power.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1A illustrates an example compact sensor system according to aspects of the present invention.

FIG. 1B illustrates the compact sensor system of FIG. 1A enhanced to show internal system components according to aspects of the present invention.

FIG. 1C illustrates a reverse angle view of the compact sensor system in FIG. 1B according to aspects of the present invention.

FIG. 2 illustrates a cross sectional view of a compact sensor system according to aspects of the present invention.

FIG. 3 illustrates a housing with cooling fins according to aspects of the present invention.

FIG. 4 illustrates a housing with conductive mounting tabs according to aspects of the present invention.

FIG. 5 illustrates a block diagram of sensor system components according to aspects of the present invention.

FIG. 6 illustrates a flowchart of a sensor data recognition process according to aspects of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

The purpose of this patent is to enhance covert operations, especially in a hostile environment, by reducing the power and bandwidth requirements of remote sensors, typically those operating where power and bandwidth are at a premium—such as in the case of a video camera mounted in an Unmanned Aerial Vehicle (“UAV”), or a remote sensor positioned covertly in hostile territory. Enhanced covert operations are critically valuable as the nature of warfare changes, and where lives are saved through the use of remote sensors and remotely piloted vehicles.

The key to enhanced covert operations is to push at least the first level data analysis to the edge of the system, where the sensors are located, as opposed to forwarding all the raw information at a central source. In today's computer intensive, high technology world, data is available from millions of sources. But it is challenging, in a centralized system, to assimilate and analyze this data due to its volume and often also due to its time sensitive nature. Because of the amount of data, it is severely limiting, both from network bandwidth perspective and processing perspective, to have all data centrally collected and then analyzed. However, if intelligence is added to the sensor module such that the data can be analyzed at the sensor, and only selected data is selected for transmission to a central control center or other location, the bandwidth and processing requirements for the system are significantly reduced. Thus, enhanced covert operations can be achieved by pushing intelligence to the edge of the information system, that is, to where the sensor is located.

Thus it is highly desirable to perform a portion of the analysis at the sensor equipment to reduce the deluge of raw data provided to a command center or other location, as an overwhelming amount of raw data slows the processing, interpretation, and discovery required to discern a credible threat in a timely fashion. Furthermore, it is desirable to increase the number of sensors collecting data from disparate sources. The ultimate goal is to increase the speed and quality of the data gathering and analysis process to create “actionable intelligence”—gathered intelligence analyzed fast enough so that action can be taken to one's benefit. When actionable intelligence is received from disparate sources, significant progress can be made “connecting the dots” using the timely information.

According to some embodiments, the sensor may be focused on identifying faces of important individuals. Instead of having a camera send raw video continuously, which is a large data stream prone to D2IJ, the camera is designed with the capability to detect whether faces are present in the frame and only send data when faces are present. Since this drastically reduces the volume of relevant data, this requires less bandwidth, less overall transmission time (making the sensor much less susceptible to D2IJ), and also consumes much less power since the system is no longer continuously transmitting. In another embodiment, the sensor system is sent a particular face to look for, and data is only sent when the face is identified, thereby reducing D2IJ, the duration of bandwidth use, and the power consumption even further. In yet another embodiment, the sensor system does the image analysis and comparison, and only emits a brief signal sufficient to indicate the face that was identified. In some embodiments, this signal may be a confirmation message comprising numerical data corresponding to a particular target image, and/or date and/or time information corresponding to the date/time the target was detected. Additionally, the signal may be encrypted to avoid detection. Notably, in some embodiments, the confirmation message does not include the actual image data, thus greatly reducing the volume of data to be sent. Such a brief transmission is practically immune to D2IJ, and consumes very little power and bandwidth, since the image data is never sent, just the confirmation message.

In addition to the benefits of reduced power and bandwidth consumption, the use of a brief confirmation message corresponding to the detection of a target dramatically reduces “chatter.” Although enemy intelligence may not be able to decode a transmitted signal, they may monitor the volume of communications and a high volume of intercepted communications (chatter) may tip off the enemy that they have been detected. Thus by using short confirmation messages, and, in some embodiments, storing and/or bundling messages for transmission at a selected time, chatter is dramatically reduced and the system is more difficult to detect.

Still other D2IJ avoidance tactics can be implemented such as automatically turning the system off for certain periods of time, or coming up in listening mode at a particular time to receive new instructions such as target information, operation mode, when to transmit, as well as what frequency, modulation, interval and/or encryption key to use when transmitting.

Facial recognition is just one example of the data analysis that may be performed by the sensor system. The analysis alternatively or in combination includes the detection of edges, objects, and other visual characteristics as well as second and third order effects such as the rate in which objects or faces are being introduced into the field. For example, in one embodiment, a sensor system uses edge detection and character recognition to identify and analyze license plates.

Algorithms for performing image processing can be found in many engineering textbooks, such as “Digital Image Processing” by Rafael C. Gonzalez & Richard E. Woods (3^{rd} edition 2008) which is incorporated by reference in its entirety. In some embodiments of the present disclosure, software libraries, such as Open Source Computer Vision Library (“OpenCV”), available at http://opencv.org/, are used to provide software capabilities for real-time computer vision and related image processing functionality.

Many different types of sensors may be used with the system, including cameras for certain regions of the electromagnetic spectrum, temperature and other environmental sensors, electromagnetic signal sensors including cellular phone activity, audio, and pressure sensors, as well as accelerometers and position sensors. Additionally, multiple sensors can be used in combination.

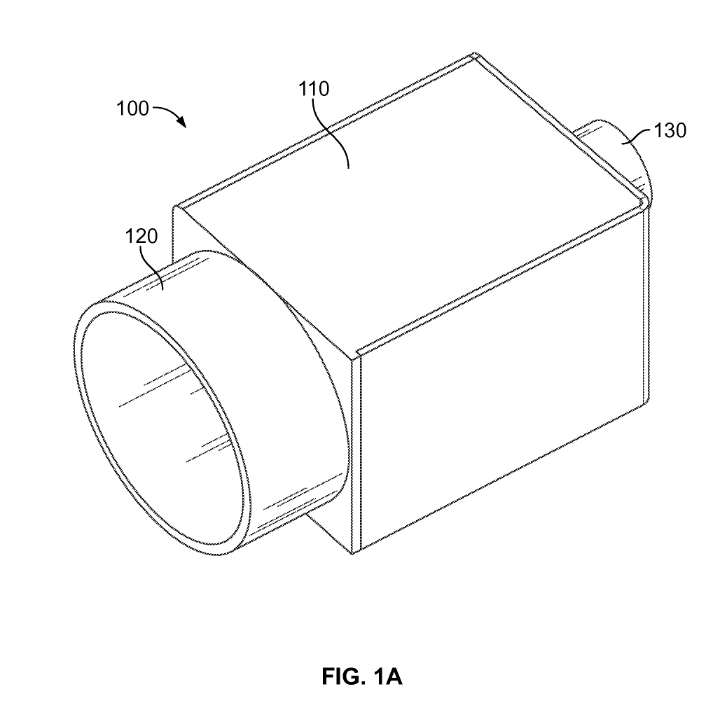

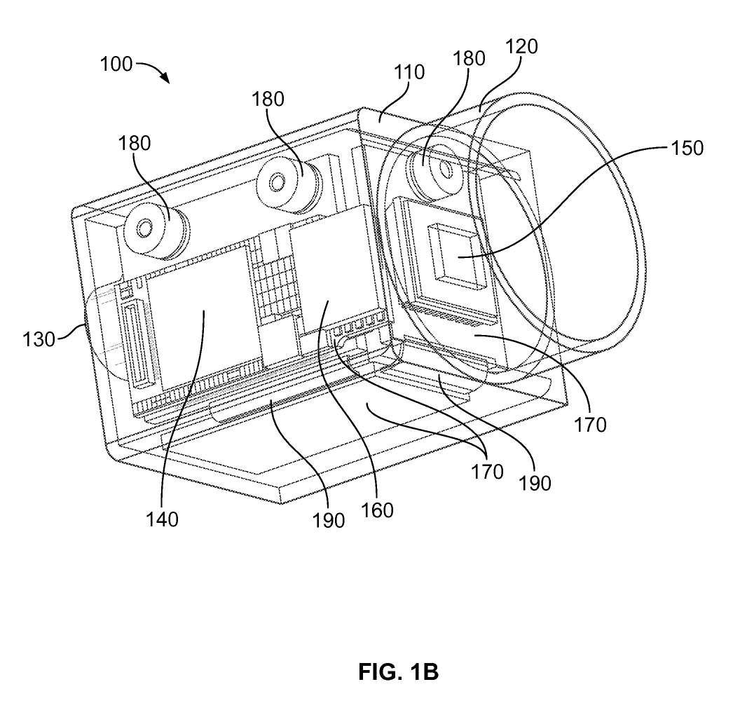

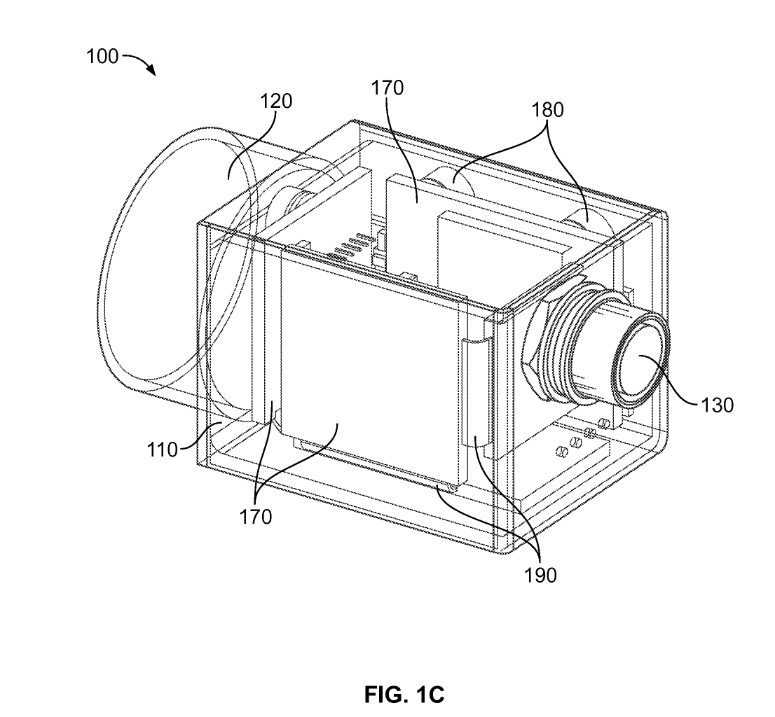

Referring to FIG. 1A, an external view of a compact sensor system 100 according to aspects of the present invention is illustrated. The system 100 includes a housing 110, an aperture 120, and a connector 130. The housing 110 contains system components as detailed below in the discussion of FIGS. 1B-1C. The housing may be made of any rigid or semi-rigid material, but preferably from a material that can conduct heat. In some embodiments, the housing 110 is made of metal. As shown, an aperture 120 is attached to the housing 110. The aperture is configured to limit and/or focus the energy received by the sensor (the sensor is not visible in this view, but can be seen in FIG. 1B). The aperture size can be selected to optimize the reception of visible light, sound, heat, infrared radiation, or other information. In some embodiments, the aperture is adjustable.

As shown, a connector 130 is attached to the housing 110. The connector can be a female or male connector used for attaching a cable to the system 100, such that the system can receive input and deliver output to an external device. In some embodiments, the connector 130 is a female or male multi-pin connector, such as an 8-pin or 12-pin connector. In other embodiments, the connector 130 may be configured for Ethernet, Universal Serial Bus (USB), S-Video, HDMI, DVI, or other type of interface. In some embodiments, multiple connectors 130 are provided. Additionally, some embodiments will not include a connector 130, for a variety of reasons including reducing size, reducing cost, reducing power consumption, or because the system is intended to use solely wireless communication.

Referring to FIG. 1B, a transparent view of the compact sensor system 100 is shown so that internal components of the system can be illustrated. Internal system components include processor hardware 140, sensor 150, processor readable media 160, circuit boards 170, mounting hardware 180, and flexible circuit interconnect 190.

According to some embodiments, the processing hardware 140 is a general purpose microprocessor capable of performing mathematical computations sufficient to support real-time digital signal processing applications. In some embodiments, a general purpose processor with a low power requirement, which generates a lower amount of heat, is used as the processing hardware 140. For example, in some embodiments, a processor based on the ARM Cortex A8 or A9 core, such as the Texas Instruments 37xx or 41xx processor families may be used as the processing hardware 140. In some embodiments, the processing hardware 140 is designed with advanced capabilities for digital signal processing, such as vector processing, pipelining, and/or multi-processor capabilities. The processing hardware 140 is attached to a circuit board 170. A processor readable media 160 is also attached to a circuit board 170, and connected to the processing hardware 140 via connections on the circuit board 170 allowing the processing hardware 140 to read from, and optionally write to, the processor readable media 160. The processor readable media 160 stores software instructions to be executed by the processing hardware. As shown, the processing hardware 140 and processor readable media 160 are located on the same circuit board 170, but in alternative embodiments the processor hardware 140 and processor readable media 160 can be located on separate circuit boards 170. In some embodiments, the processor readable media 160 is a memory chip disposed on the circuit board 170. In alternate embodiments, the processor readable media 160 may be replaced with, or supplemented by, an external memory device connected via an external connector 130, such as a portable USB memory device.

As shown in FIG. 1B, the sensor 150 is also attached to a circuit board 170. The sensor 150 is in communication with the processor hardware 140 via the circuit boards 170 and flexible circuit interconnect 190. In this embodiment, in order to save space and promote heat dissipation, multiple circuit boards 170 are oriented on the x, y, and z axes such that they are positioned along the interior wall of the housing 110. Additionally, the boards 170 can be positioned in a parallel formation, however, the perpendicular arrangement as shown in FIG. 1B is preferable for heat dissipation. The multiple circuit boards 170 are communicatively coupled to each other via the flexible circuit interconnect 190 running between the boards 170. Alternatively and preferably, custom printed circuit boards can be used, such as those formed from flexible polymer sheets to allow for additional configuration options (commonly referred to as “flexible circuits”). In the context of this disclosure, flexible circuits include “rigid-flex” circuits, where “rigid-flex” is a multilayer printed circuit board with both rigid and flexible electric interconnecting layers. Flexible circuits allow for the replacement of the multiple circuit boards 170 and flexible circuit interconnect 190 with a single circuit board having improved reliability.

The sensor 150 collects data from information passing through the aperture 120. In one embodiment, the sensor 150 is a camera collecting visual data. In another embodiment, the sensor 150 is configured to detect other non-visual electromagnetic radiation, which may include for example, infrared or ultraviolet signals. Alternatively, the sensor 150 is configured to collect sound data. In yet another embodiment, the sensor 150 is configured to detect cellular communications such as from a wireless phone. In still another embodiment, the sensor 150 is configured to collect thermal data.

The sensor 150 collects sensor data and transfers the data to the processing hardware 140. The processing hardware 140, according to the software instructions on the computer readable media 160, processes and analyzes the sensor data. In some embodiments, the processor hardware 140 transmits output data containing a description of the analyzed sensor data to a remote location. In a second mode, the amount of output data is reduced such that the processor hardware 140 only transmits a fractional amount of data as compared to the original sensor data. In a third mode, the processor hardware 140 receives a target data set from an external source, and, when a match between the sensor data and the target data is recognized, the processor hardware 140 transmits data indicating the recognition of the target. In yet another mode, upon detecting a match the processor hardware 140 transmits only a confirmation signal without any sensor data.

The circuit boards 170 are attached to the housing 110 by the mounting hardware 180. As the processing hardware 140 and the circuit board 170 may generate significant heat when the processing hardware 140 is processing data, the mounting hardware 180 preferably is prepared using a material conductive of heat, such that the mounting hardware 180 can act as a heat sink. Additionally, if the housing 110 is also made using a heat conducting material such as a metal, the use of metal mounting hardware 180 will allow the mounting hardware 180 to conduct heat away from the circuit board 170 and transfer it to the housing 110.

Additional components not shown in FIG. 1B may be added to the system. In one embodiment, the system includes circuitry to perform wireless transmission and reception of data. The wireless communication hardware is preferably mounted on a circuit board 170 and communicatively coupled with the processor hardware 140. Alternatively, the wireless communication capability can be included in the processor hardware 140.

FIG. 1C provides a reverse-angle view of the compact sensor system 100 shown in FIG. 1B. As shown in FIG. 1C, the housing 110 includes circuit boards 170 connected by flexible circuit interconnect 190. Components comprising the processing hardware and machine readable media, visible in FIG. 1B but obscured in FIG. 1C, are attached to the circuit boards 170. Optionally, the circuit boards 170 and interconnect 190 can be replaced by a single flexible circuit. The circuit boards 170 are attached to the housing 110 via mounting hardware 180. The system includes an aperture 120 and, preferably on a surface of the housing 110 separate from the aperture 120, is at least one connector 130.

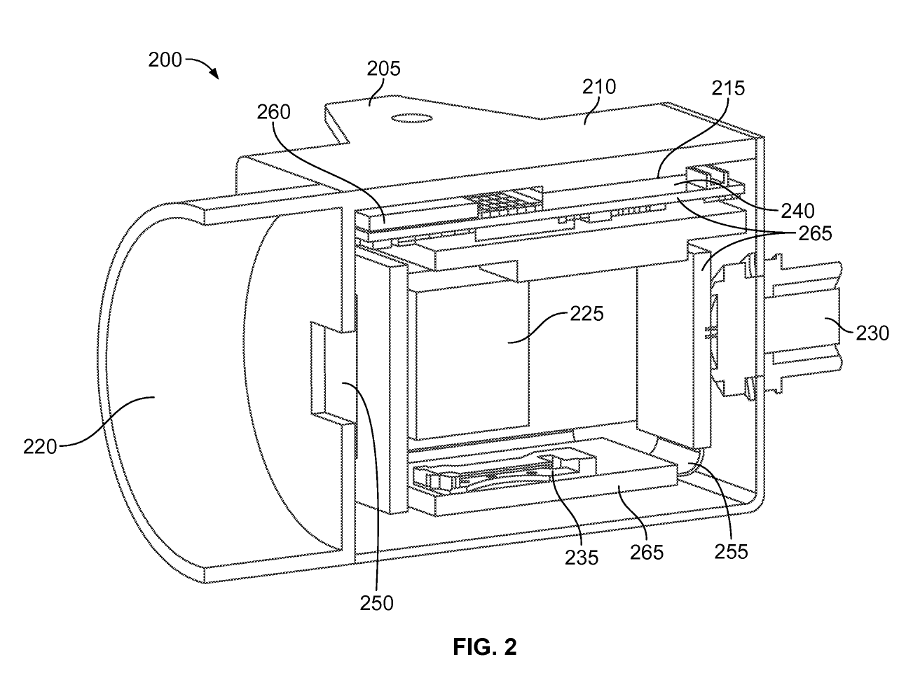

Turning to FIG. 2, a cross sectional view of a compact sensor system is shown to illustrate internal features of the sensor system. External components of the system 200 comprise a housing 210, an aperture 220, and a connector 230. In some embodiments, the housing 210 includes tab(s) 205 which provide the capability to mount the system 200 to another object, as well as providing for additional dissipation of heat. Internal components of system 200 are visible in the cross section view of FIG. 2, including processing hardware 240, sensor 250, processor readable media 260, circuit board(s) 265, flexible circuit interconnect 255, expansion slot 235, and module 225.

In the configuration illustrated in FIG. 2, system 200 comprises processing hardware 240 that is directly in contact with a portion of the housing 210 at contact region 215. By providing for a surface of the processing hardware 240 in connection with housing 210, the housing 210 is able to assist with the conduction of heat away from the processing hardware 240. In some embodiments, the system 200 is mounted to an object, for example via tab(s) 205, providing for additional heat dissipation. According to some embodiments, the system 200 is mounted to an unmanned aerial vehicle (“UAV”) in a manner allowing for transfer of heat from the housing 210 to the UAV. This configuration may allow for additional heat dissipation, such as when wind passes over a large, heat conductive surface of the UAV, for example a metal wing.

In FIG. 2, the processing hardware 240 is mounted on circuit board 265. In some embodiments, the processing hardware 240 is distributed across multiple circuit boards, such as in multiprocessor systems. The processing hardware 240 is communicatively coupled with a processor readable media 260. In order to optimize the use of internal space within housing 210, multiple circuit boards 265 may be distributed around the interior walls of housing 210, as shown in FIG. 2. In some embodiments, the circuit boards 265 are positioned in a substantially perpendicular manner to each other to allow for improved heat dissipation. In embodiments using multiple circuit boards 265, flexible circuit interconnects 255 provide a connection between circuit boards 265, for example allowing components positioned on a first circuit board 265 to communicate with components on a second circuit board 265.

According to some embodiments, the system 200 can be configured to provide for additional data storage, battery power, communications, or other capabilities specific to a desired embodiment. To provide these configuration options, system 200 may include expansion interfaces and/or other modules, such as expansion interface slot 235 and/or module 225. Expansion interface slot 235 allows for the connection of an additional component, such as a storage device (e.g. portable USB memory, microSD card, etc.). Module 225 may, depending on the desired configuration, comprise a battery, additional processor readable media, wired or wireless communication components, or other functionality for specific embodiments of system 200.

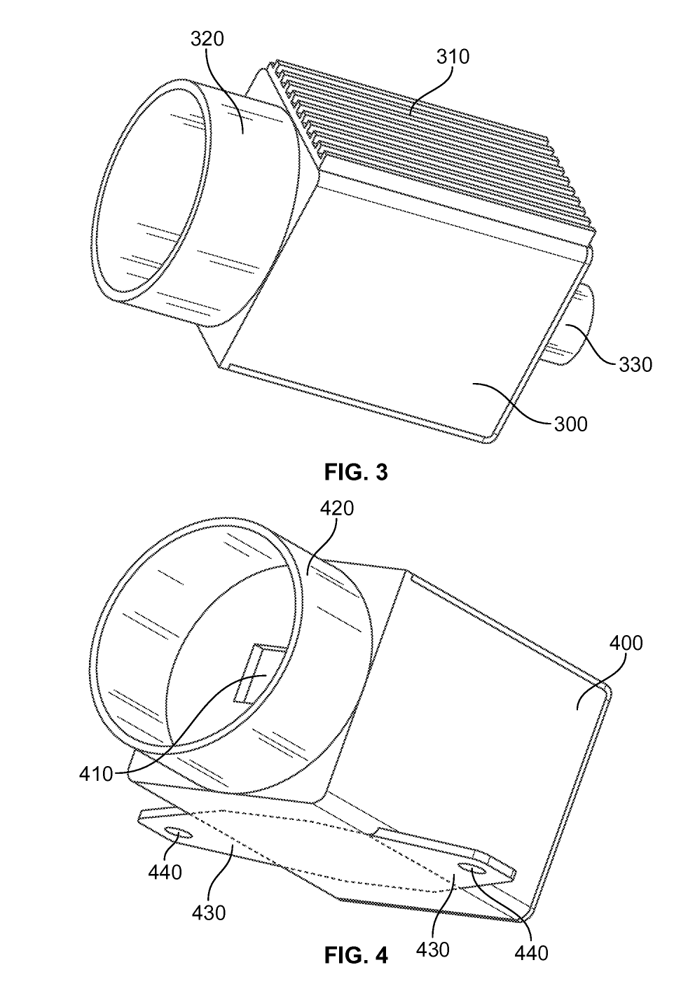

FIG. 3 and FIG. 4 illustrate selected structural features of the housing to assist in heat dissipation.

In FIG. 3 an embodiment of the compact sensor system with cooling fins is shown. The housing 300 includes, on one surface, a plurality of cooling fins 310. The cooling fins 310 are configured in a pattern to maximize surface area and airflow, thus allowing for maximum heat dissipation. Optimally, the cooling fins 310 are positioned on the housing 300 so that they share the same wall of the housing 300 as the processing hardware, positioned inside the housing 200. In some embodiments, cooling fins 310 are provided on multiple surfaces of the housing 200. Additionally, an aperture 320 and connector 330 are attached to the housing, as previously shown in FIGS. 1A-1C.

Referring now to FIG. 4, an embodiment of the compact sensor system with mounting tabs is shown. The housing 400 includes, on one surface, two tabs 430 with corresponding mounting holes 440. Additionally, the housing 400 includes an aperture 420 with a sensor 410 positioned inside the aperture 420. The tabs 430 may be made of a heat conductive material, to assist in heat dissipation. Although two tabs are shown in this embodiment, other embodiments include additional tabs 430. Alternatively or additionally, the mounting tabs 430 may be repositioned on the housing 400 to allow for mounting such that the sensor 410 is aimed at the proper area to collect optimal information. The compact sensor system can be mounted securely to a rigid surface using screws, bolts, or similar fasteners in the mounting holes 440.

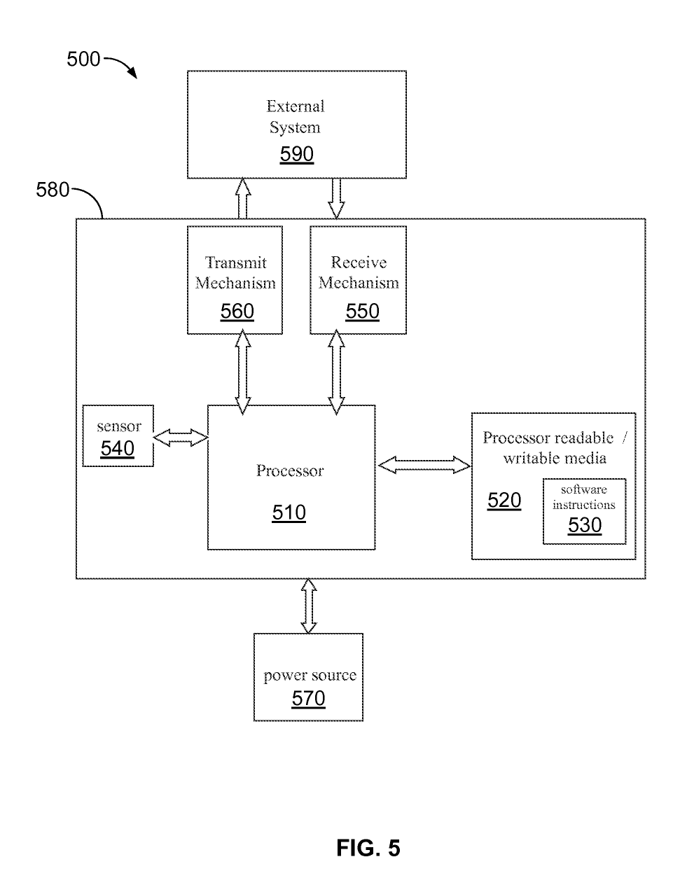

Turning now to FIG. 5, a block diagram of a compact sensor system is shown. The system 500 includes within a housing 580 a processor 510 connected to a processor readable media 520. As discussed above, the processor 510 may be any general purpose processor, such as those made by Intel, AMD, Motorola, or other manufacturers. Optionally, the processor 510 includes enhanced capabilities for data processing including pipelining, vector processing, or other enhancements. The processor 510 may be comprised of any combination of hardware, software, or firmware that is configured to process data and communicate with other system components. The processor readable media 520 contains software instructions 530 that, when executed by the processor 510, cause the processor 510 to receive and analyze sensor data from the sensor 540, which is communicatively coupled to the processor 510.

As shown in FIG. 5, the system 500 has a receive mechanism 550 for receiving external data, and a transmit mechanism 560 to transmit data to an external component. Both the receive mechanism 550 and transmit mechanism 560 are communicatively coupled to the processor 510. The receive mechanism 550 can be configured to receive data from an external source via either a wired connection or via wireless communication, or both. Similarly, the transmit mechanism 560 can be configured to transmit data to an external component via either a wired connection or via wireless communication, or both.

The receive mechanism 550 can operate to receive data and/or control instructions from an external source and communicate the data and/or instructions to the processor 510. Such data may include target data that the processor 510 is to search for in the data provided from the sensor 540. Control instructions received from an external source by the receive mechanism 550 and provided to the processor 510 may include control settings such as power-on/power-off times, analysis mode selection, transmit mode selection, and other configurable control settings. Additionally, control instructions received from the external source may include transmission specifics such as frequency, bandwidth restrictions, transmit times, and other instructions.

The system 500 is powered by a power source 570. As shown here, the power source 570 is external to the unit housing 580, however, the power source may be optionally included inside the housing 580. In some embodiments, the power source 570 is external to the housing 580 and rechargeable by solar power. In other embodiments, the power source 570 is a larger battery external to the housing 580 to allow for additional covert configuration options. For example, the battery may be buried underground with wires running to the housing 580, or otherwise as a particular configuration requires for minimizing detectability. In other configurations, the power source 570 may be a smaller battery located inside the housing 580. Alternatively, the system 500 can receive power from a hardwired electricity source.

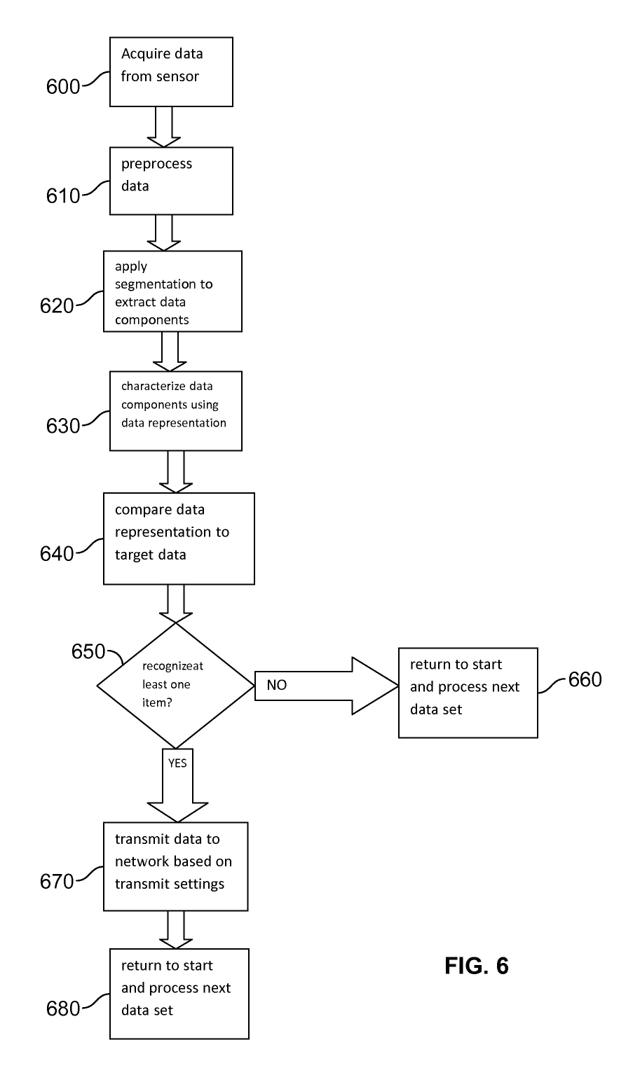

Turning to FIG. 6, a flowchart for analysis of sensor data is shown. This particular embodiment is directed toward the recognition of a specific target image within a set of image data provided by a sensor. Initially, at 600, the processing hardware receives a set of data from a sensor. The processing hardware then preprocesses the data at 610. The preprocessing includes applying filtering or noise reduction to the image as necessary to improve the quality of the received sensor data. Next, at 620, the processor segments the image data to subdivide the image into subcomponents. In some embodiments, this segmentation process is tuned to the specific objects of interest. For example, if the system is designed to detect vehicles, the segmentation process would focus on edge detection so that outlines of objects would be recognizable during subsequent processing. Many methods for segmentation exist and are publicly available, such as those described in the Gonzalez & Woods “Digital Image Processing” reference incorporated by reference herein, and can be implemented using image processing libraries such as the OpenCV library referenced above or other image processing software.

At 630, the modified image data is stored using a representative data representation. The representation is, preferably, optimized to the type of target data received and analysis required. For example, an analysis focused on boundary, or edge, detection can use chain codes, polygonal approximations, boundary segments such as a convex hell, or other representations. At 640, the representative data from 630 is compared to the target data received from an external system. If at least one element of the target data is recognized in the representative data, then the processor will continue to 670. If not, the processor will proceed to 660, where the data is deleted and the processor returns to 600 and begins the algorithm again with a new set of sensor data. Optionally, the data is not deleted at 660, and instead a method, such as a circular queue, is used to periodically overwrite the oldest data.

At 670, the processor has identified at least one target item in the data, and therefore will communicate information to an external device indicating that the item(s) were found. In some embodiments, the processor will cause the recognized data to be transmitted. In other embodiments, the processor will only send information indicating a “hit”—but not the actual data itself. In some embodiments, the transmission settings are configurable and allow for multiple options. Additionally, in some embodiments, the data to be transmitted is stored and potentially aggregated with other data for transmission at a specified time, e.g. at midnight each day. After concluding 670, the processor proceeds to 680 to release any temporary data and return to the start to analyze a new data set.

While the present invention has been described in connection with a number of exemplary embodiments, and implementations, the present inventions are not so limited, but rather cover various modifications, and equivalent arrangements, which fall within the purview of prospective claims. For example, although some aspects of the present invention may be described with reference to separate elements, it is understood that some elements may be combined to provide an integrated structure while satisfying the functions of the elements. In addition, although aspects of the present invention may be described in separate embodiments, it is contemplated that the features from more than one embodiment described herein may be combined into a single embodiment. Furthermore, it is also understood that aspects of the present invention are not limited to the particular shapes and dimensions described or illustrated in this present application.

What we claim is:

1. A compact sensor system for capturing and processing sensor data, comprising:
a housing;
at least one sensor disposed in the housing and capturing sensor data;
processing hardware for performing sensor data processing, the processing hardware disposed on at least one circuit board, the circuit board disposed in the housing, the processing hardware receiving the sensor data from the sensor;
a processor readable media storing imaging software instructions; and
wherein the processing hardware processes the sensor data according to the software instructions, the instructions including the steps of:
identifying bits in the sensor data;
analyzing the bits by segmenting the sensor data; and
describing the segmented sensor data using a data representation.

2. The system of claim 1, wherein the housing has a volume of less than two cubic inches.

3. The system of claim 1, wherein a battery is disposed in the housing, the battery providing power to the processing hardware and at least one sensor.

4. The system of claim 3, wherein the battery is rechargeable by solar power.

5. The system of claim 1, wherein the processing hardware transmits output data containing the description of the segmented sensor data to a remote location.

6. The system of claim 5, wherein the system performs intelligent transmission control to minimize power consumption and reduce detectability.

7. The system of claim 6, wherein at least one sensor is a camera, wherein the segmentation of the sensor data is directed to facial recognition, and wherein output data is only transmitted when at least one face is detected.

8. The system of claim 6, wherein the system is configured to shut off periodically, thereby reducing the amount of power required.

9. The system of claim 6, wherein the number of transmissions is reduced by storing and aggregating output data.

10. The system of claim 5, wherein the transmission occurs via wireless communication.

11. The system of claim 5, wherein only a portion of the captured sensor data is transmitted.

12. The system of claim 5, wherein the processing of the sensor data according to the instructions reduces an amount of output data by a factor of at least 100 relative to the original sensor data.

13. The system of claim 1, wherein the compact sensor system further comprises a heat reduction system that dissipates heat produced by the processing hardware.

14. The system of claim 13, wherein the heat reduction system includes at least one heat sink.

15. The camera system of claim 14, wherein the heat sink is integrated into the housing.

16. The system of claim 13, wherein the processing hardware is coupled to the housing such that heat is transferred from the processing hardware to the housing by conduction.

17. The system of claim 13, wherein the housing includes at least one external cooling fin to allow convection cooling.

18. The system of claim 13, wherein the housing includes at least one mounting tab that provides conduction of heat to an external device.

19. The system of claim 1, wherein the at least one circuit board includes at least one flexible circuit board.

20. The system of claim 19, wherein the processor hardware is positioned such that at least one section of the flexible circuit board is perpendicular to another section of the flexible circuit board.

21. The system of claim 19, wherein the processor hardware is disposed on a plurality of sections of the flexible circuit board, the sections being respectively coupled to a separate wall of the housing.

22. The system of claim 1, wherein the instructions include the step of recognizing a predetermined object within the segmented sensor data.

23. The system of claim 1, wherein the processing hardware receives target data from an external source, the processing hardware compares the sensor data to the target data, and, in response to recognizing a match between the sensor data and target data within a predetermined threshold, the processing hardware transmits output data indicating the recognition of the target data within the sensor data.

24. The system of claim 23, wherein the output data is less than 256 bytes.

25. The system of claim 23, wherein the output data includes a confirmation signal without any accompanying sensor data.

26. The system of claim 1, wherein the processing hardware is capable of performing real-time processing of the sensor data.

27. The system of claim 1, wherein at least one sensor is a camera capturing image data.

28. The system of claim 1, wherein at least one sensor is configured to capture thermal imaging data.

29. The system of claim 1, wherein at least one sensor is configured to capture electromagnetic radiation data occurring outside of the visible spectrum.

30. A method of capturing and processing sensor data using a compact sensor system, the sensor system comprising a housing, a sensor, processing hardware, and a heat reduction system, the method comprising:
capturing sensor data via the sensor;
transmitting the sensor data to the processing hardware;
identifying, via the processing hardware, bits in the sensor data;
analyzing, via the processing hardware, the bits by segmenting the sensor data;
describing, via the processing hardware, the segmented sensor data using a data representation; and
dissipating heat produced by the processing hardware, via the heat reduction system.

31. The method of claim 30 further comprising:
receiving target data;
comparing the target data to the segmented sensor data; and,
transmitting, upon recognizing a match between the segmented sensor data and the target data, output data confirming the detection of the target data by the sensor.

32. The method of claim 31 further comprising wherein the output data is stored for transmission at a later time.

33. A compact camera system for capturing and processing image data, comprising:
a housing,
at least one camera disposed in the housing and capturing image data;
processing hardware for performing image processing, the processing hardware disposed on at least one flexible circuit board, the flexible circuit board disposed in the housing, the processing hardware receiving image data from the camera;
a processor readable media storing imaging software instructions; and
at least one heat sink dissipating heat,
wherein the processing hardware processes the image data to create segmented object data and transmits the segmented object data to a remote location

34. The camera system of claim 33, wherein the processing of the image data reduces an amount of segmented object data by a factor of at least 100 relative to the image data.

35. The camera system of claim 33, wherein the processing hardware receives a target image from an external source, the processing hardware compares the image data to the target image, and, in response to recognizing the image, the processing hardware transmits output data indicating the recognition of the target image within the image data.

36. The camera system of claim 35, wherein the output data includes a confirmation signal without any accompanying image data.
